(19) United States
(12) Patent Application Publication
(10) Pub. No.: US 2022/0204188 A1
(43) Pub. Date: Jun. 30, 2022

(54) PROPULSION SYSTEM FOR SATELLITES

(71) Applicant: Swarm Technologies, Inc., Mountain View, CA (US)

(72) Inventors: Benjamin LONGMIER, Portola Valley, CA (US); David HASH, Mountain View, CA (US)

(21) Appl. No.: 17/499,634

(22) Filed: Oct. 12, 2021

Related U.S. Application Data
(60) Provisional application No. 63/092,676, filed on Oct. 16, 2020.

(51) Int. Cl. B64G 1/40; B64G 1/42; F02K 9/58; F02K 9/60

(52) U.S. Cl. CPC B64G 1/401; B64G 1/402; F02K 9/605; F02K 9/58; B64G 1/425

(57) ABSTRACT

A satellite includes a housing, a circuit board containing circuitry, a battery electrically connected to the circuit board, a tank, an expandable balloon disposed in the tank, a heater, a valve providing liquid communication between the tank and the heater when in an open position and providing no liquid communication between the tank and the heater when in a closed position, and a nozzle having an orifice in liquid communication with the heater. Operating the satellite includes partially filling the expandable balloon with a gas, loading liquid fuel into the tank, launching the satellite into space, opening the valve to cause the liquid fuel from the tank to pass into the heater under pressure provided by the gas in the expandable balloon, activating the heater to heat and vaporize the liquid fuel into a fuel vapor, and expelling the fuel vaper out of the nozzle.

### RELATED APPLICATIONS

This application claims the benefit of U.S. Provisional Application No. 63/092,676, filed Oct. 16, 2020, and which is incorporated herein by reference.

### FIELD OF THE INVENTION

The present invention relates to satellites, and more particularly to small scale satellites.

### BACKGROUND OF THE INVENTION

Artificial satellites have traditionally been relatively large-scale devices deployed in orbits about the earth for observation of the earth's surface, or carrying directive antennas for use as communications repeaters. Many such satellites must be maneuvered in earth's orbit to function effectively. However, the effective life of propulsion systems is limited by the amount of fuel carried aboard the satellite, as well as by the rate of expenditure of fuel required to maneuver the satellite.

More recently, smaller, single use satellites have been contemplated. However, as the size of satellites are reduced, it becomes more difficult to scale down the size and power/fuel consumption of devices used to maneuver the satellite once in orbit. Specifically, it is difficult to miniaturize a propulsion system (nozzle, propellant feed system, propellant tank, and gauges) into the size of a small satellite. As such, present small satellite propulsion systems provide very low thrust (measured in Newtons), and/or very low total impulse (measured in Newton-seconds). Further, most propulsion systems use fuel that is stored on board the satellite as a pressurized gas, which complicates launching the satellites into orbit. Finally, a figure of merit for how effective a propulsion system is within a given volume or within a given mass can be expressed as: “Impulse mass density” (N−s/kg) and Impulse volume density” (N−s/L). It would be desirous to maximize both of those values in a propulsion system that still fits within the size constraints of small satellites.

### BRIEF SUMMARY OF THE INVENTION

The aforementioned problems and needs are addressed by a propulsion system that includes a tank, an expandable balloon disposed in the tank, a heater, a valve providing liquid communication between the tank and the heater when in an open position and providing no liquid communication between the tank and the heater when in a closed position, and a nozzle having an orifice in liquid communication with the heater.

A satellite includes a housing, a circuit board containing circuitry and disposed in the housing, a battery disposed in the housing and electrically connected to the circuit board, a tank disposed in the housing, an expandable balloon disposed in the tank, a heater, a valve providing liquid communication between the tank and the heater when in an open position and providing no liquid communication between the tank and the heater when in a closed position, and a nozzle having an orifice in liquid communication with the heater.

A method including providing a satellite that include a housing, a circuit board containing circuitry and disposed in the housing, a battery disposed in the housing and electrically connected to the circuit board, a tank disposed in the housing, an expandable balloon disposed in the tank, a heater, a valve providing liquid communication between the tank and the heater when in an open position and providing no liquid communication between the tank and the heater when in a closed position, and a nozzle having an orifice in liquid communication with the heater. The method further includes partially filling the expandable balloon with a gas, loading liquid fuel into the tank, launching the satellite into space after the providing, the partially filling and the loading, and after the launching, opening the valve to cause the liquid fuel from the tank to pass into the heater under pressure provided by the gas in the expandable balloon, activating the heater to heat and vaporize the liquid fuel in the heater into a fuel vapor, and expelling the fuel vaper out of the nozzle.

Other objects and features will become apparent by a review of the specification, claims and appended figures.

### BRIEF DESCRIPTION OF THE DRAWINGS

FIG. 1A is a perspective view of the satellite.

FIG. 1B is a perspective view of the frame of the satellite.

FIG. 1C is a top view of the satellite with the top panel removed.

FIG. 1D is a perspective view of the satellite with the top panel removed.

FIG. 1E is a top view of the satellite.

FIG. 1F is a perspective view of the satellite.

FIG. 1G is a side view of a stack of the satellites.

FIG. 2 is a side cross sectional view of the propulsion system, where the fuel tank is essentially full of fuel.

FIG. 3 is a side cross sectional view of the propulsion system where the fuel tank is essentially depleted of fuel.

FIG. 4 is a side cross sectional view of the propulsion system where the fuel tank is integrally formed with at least a portion of the frame of the satellite.

FIGS. 5 and 6 are graphs that show thrust performance that has been achieved by the propulsion system of the present invention.

### DETAILED DESCRIPTION OF THE INVENTION

The present invention is directed to a miniature satellite that accomplishes all or virtually all its major functions (e.g. two-way communications) using circuitry on a single circuit board, yet includes an effective propulsion system for maneuver the satellite while in orbit. The satellite can stabilize itself in Low Earth Orbit (LEO), and groups of such satellites can spread out in orbit from one another.

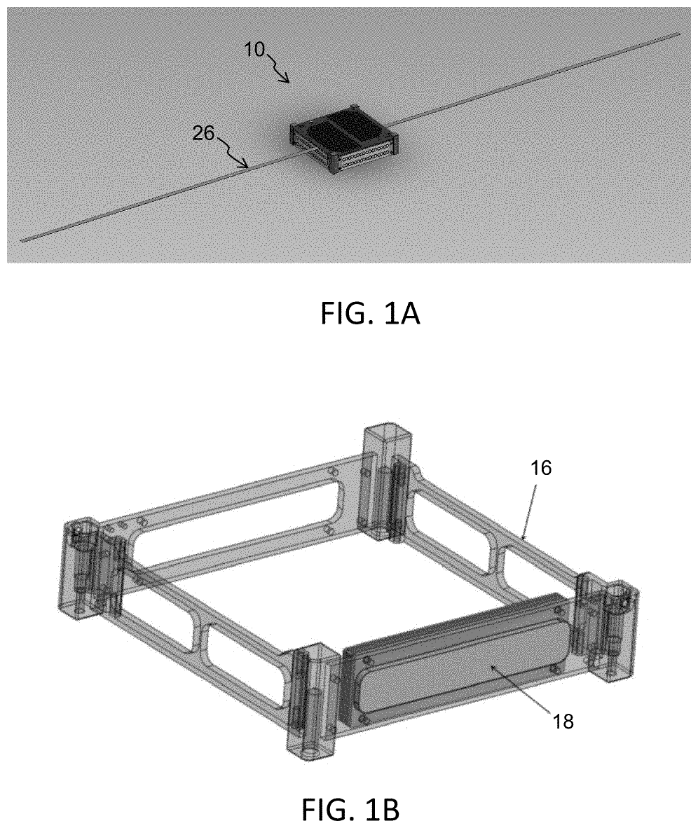

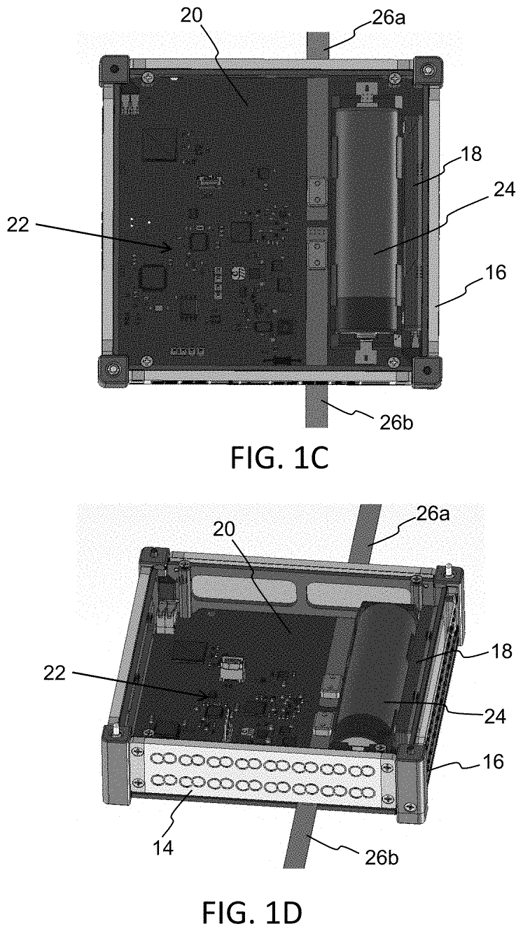

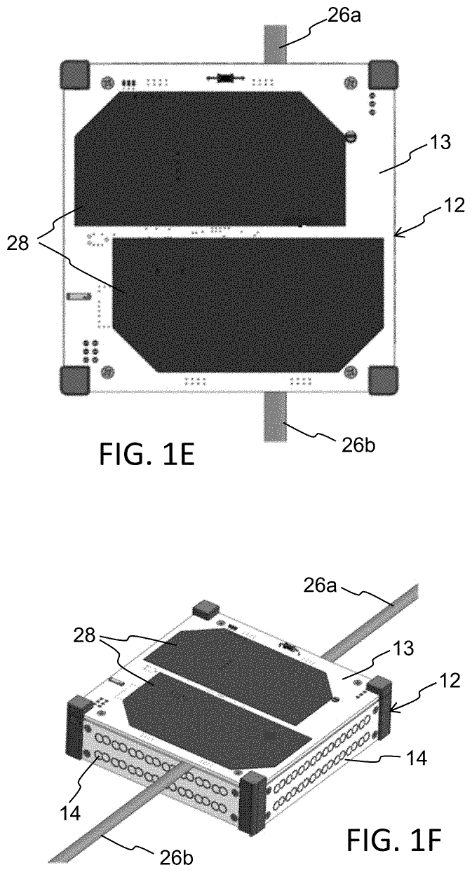

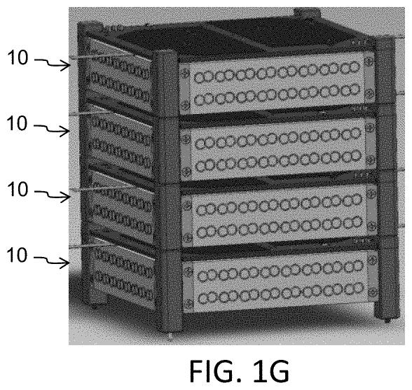

As shown in FIGS. 1A-1G, the satellite 10 includes a housing 12 made of opposing top and bottom panels 13 and side panels 14, mounted to a frame 16 preferably made of a lightweight metal such as an aluminum alloy (e.g., aluminum 7075, 6061, 5005, and/or 5052). One or more dense weights 18 are mounted to one side of the frame 16 (i.e. away from a center of the housing 12). The weight(s) 18 can be one or more of steel, stainless steel, lead, iron, copper, tungsten, depleted-uranium, nickel, ceramic, or any other relatively dense material). A printed circuit board (PCB) 20 is disposed inside the housing 12 and includes circuitry 22 for performing the operational functions of the satellite 10, and a power supply 24 (e.g., a lithium-ion battery 24) for powering those operational functions. Preferably, the battery 24 is positioned near one edge of the PCB and adjacent the weight(s) 18 to contribute to the asymmetrical distribution of mass. A dipole antenna 26 is mounted to the PCB 20, and includes a first segment 26a extending out of the housing 12 in one direction and a second segment 26b extending out of the housing 12 in an opposite direction. Preferably, the antenna is mounted closer to the same edge of the PCB that is adjacent the weight(s) 18, to further contribute to the asymmetrical distribution of mass. One of the functions of circuitry 22 is communications using antenna 26, as discussed further below. One or more solar panels 28 are formed on one or both of the top and bottom panels 13, and are connected to the PCB 20 for providing power to the circuitry 22 and/or to recharge battery 24.

In a non-limiting example, preferably, satellite 10 is ¼-U in size or smaller (where 1 U is defined as a CubeSat standard of 10 cm×10 cm×10 cm) and a mass of less than 1.33 kg. Therefore, the satellite's preferred dimensions (approximately 10 cm×10 cm×2.5 cm) are compatible with standard carrier containers (e.g. P-PODs). When stacked together as shown in FIG. 1G for deployment by a single launch vehicle, multiple satellites 10 slide along the standard CubeSat deployment rails inside of the carrier, and therefore do not require customized deployment systems. The satellite's printed circuit board (PCB) area is 9.5 cm×9.5 cm, allowing each satellite to be manufactured with traditional electronics pick and place machines. Mass production can be achieved at low cost, since all or virtually all of the satellite electrical components are on a single circuit board. Once the satellite is manufactured and all components are assembled, the entire satellite, including onboard solar panel(s) 28, occupies a volume of 280 cubic centimeters. The satellite electronics are largely shielded from low energy total ionizing dose (TID) space radiation by the PCB material on the space-facing surface, and the software operated by the circuitry 22 provides an additional layer of redundancy with a watchdog timer and a redundant software bootloader for single event upsets (SEUs).

Preferably, circuitry 22 performs most if not all of the satellite functions, including power collection, power management, sensors, 2-way radio, propulsion, etc. Circuitry 22 is placed on a single printed circuit board PCB 20. This allows for very high quality builds, fast manufacturing times, and simplified qualification testing on the ground. The design of satellite 10 is ideal for mass manufacturing, which reduces production time by many orders of magnitude compared to current state-of-the-art satellite manufacturing processes (24 hours instead of a typical 6 months to 3 year build time).

The satellite 10 serves all of the functions of a typical two-way communications satellite, supporting data relay from ground-to-space, space-to-space, and space-to-ground at a fraction of the size and cost of traditional communications satellites. The result is that the satellite is 1/10,000th the mass of similar communications satellites, can be manufactured for less than 1/1,000th the cost, and can be launched for 1/10,000th the cost due to its small mass. The satellite's functions performed by circuitry 22 include receiving data, processing data, storing data, transmitting data, networking with other satellites in space or other communications nodes on the ground, and executing all events with on-board scheduling that optimizes power consumption and data transfer.

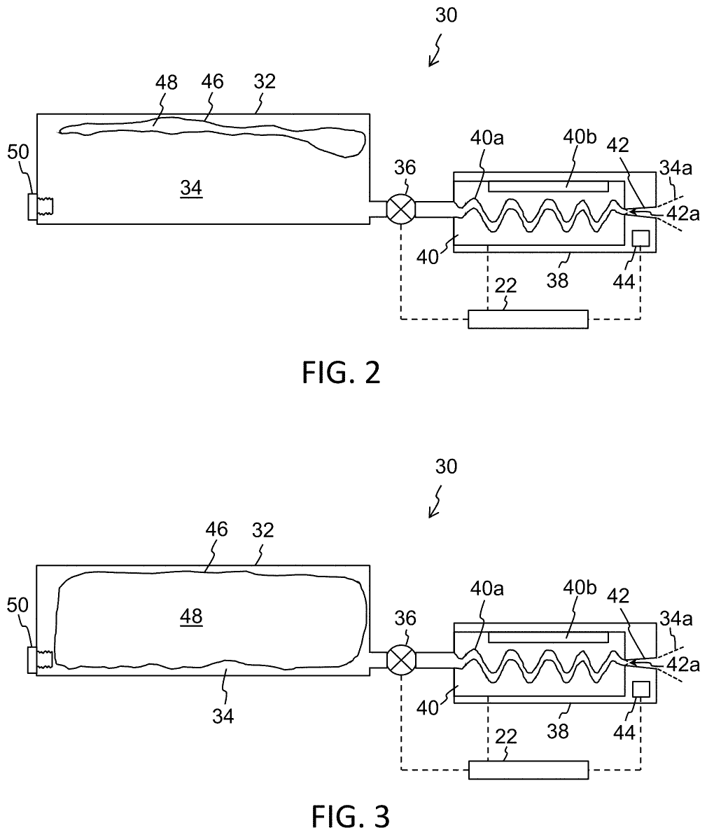

FIG. 2 illustrates the propulsion system 30 that is included in satellite 10. The propulsion system 30 includes a tank 32 that contains fuel (also referred to herein as propellent) 34, a valve 36 movable between closed and open positions for selectively releasing the fuel 34 from the tank 32 and into a heat exchanger 38, the heater 40 (as part of the heat exchanger 38) is configured to heat and vaporize the fuel 34 passed by the valve 36, a nozzle 42 is configured to inject the fuel 34 in vapor form into space to create thrust, and a temperature sensor 44. The fuel 34 in tank 32 is in liquid form. A non-limiting example of the fuel 34 is butane. The tank 32 includes an expandable balloon 46 partially filled with a gas 48 such as air or nitrogen (i.e., filled to the point that the balloon is expanded below its full range of expansion). After the fuel 34 is loaded into the tank 32 through a fill valve 50, the balloon 46 and tank 32 are sealed before launch, so that both the liquid fuel 34 and the gas 48 in the balloon 46 are at substantially 1 atmospheric pressure (i.e., 14.7 psi, or roughly 1.0 bar, which is the atmospheric pressure at the launch site). After launch into space, the liquid fuel 34 and balloon 46 are pressurized relative to zero pressure space outside of the satellite (14.7 psi in the tank 32 and balloon 46, versus the zero pressure vacuum of space).

The various components of the propulsion system (e.g., the valve 36, the heater 40, etc.) are operated by the circuitry 22. In operation, when propulsion is needed from the propulsion system 30, the pressurized liquid fuel 34 in tank 32 is driven by the pressure provided by the gas 48 in balloon 46 into heater 40 by opening valve 36 (i.e., the valve 36 provides liquid communication between the tank 32 and the heater 40 when in its open position whereby liquid fuel 34 passes from the tank 32 to the heater 40 under pressure provided by gas 48 in the balloon 46, and provides no liquid communication between the tank 32 and the heater 40 when in its closed position). The heater 40 includes a machined part having a channel 40a for the liquid fuel 34 to pass through (i.e. flow through), where the channel 40a is heated by a heating element 40b. To increase heating efficiency, channel 40a can be non-linear and circuitous, so as to lengthen channel 40a. The liquid fuel 34 passing through channel 40a of the heater 40 is heated and vaporized into a fuel vapor 34a, which in turn is provided to nozzle 42 which includes an orifice 42a that is in liquid communication with the heater. Nozzle 42 expels the warm/hot fuel vapor 34a out of the orifice 42a in a guided way so as to produce meaningful thrust for the satellite 10. The heater 40 preferably includes a single flat polyimide heating element to keep the heater 40 at a sufficiently high temperature so as to insure that all of the liquid fuel 34 passing through the heater 40 is vaporized into the fuel vapor 34a prior to exiting out through nozzle 42. Temperature sensor 44 detects the temperature of the heater 40 and provides that temperature information to circuitry 22, which uses that temperature information to control the temperature of heater 40 (i.e. control the heater based upon the temperature detected by the temperature sensor 44 to ensure heater 40 is maintained at the desired temperature for vaporizing fuel 34 inside the heater 40). By using only a single valve 36 in the propulsion system 30 to provide the fuel 34 from the tank 32 to the heater 40, an increased impulse mass density (N−s/kg) and impulse volume density (N−s/L) is achieved.

In order for the fuel 34 to be efficiently injected through the single valve 36 and into heater 40, the liquid fuel 34 in the tank 32 must be pressurized (relative to the heater 40). A material with a low thermal conductivity (polyimide, Teflon, mica, PEEK, etc.) is used between the heat exchanger 38 and the rest of the satellite frame 16 and tank 32. This reduces the heat transfer between the hotter heat exchanger 38 and the colder satellite frame 16 and tank 32, and means less power is used to pre-heat the heat exchanger 38 prior to activating the propulsion system 30. In order to pressurize the liquid fuel 34 within the fuel tank 34, partially filled gas balloon 46 is used within the fuel tank 34. The balloon 46 provides pressure on the liquid fuel 34 in tank 32, to drive the fuel 34 through valve 36 when it is opened. As the liquid fuel 34 is used up for propulsion firings, the balloon 46 expands in volume (at the expense of dropping in pressure) to fill the remaining space within the liquid fuel tank 32 and keep pressure on the fuel 34 in tank 32 (i.e., balloon 46 is an expandable balloon). A minimum pressure is therefore maintained at all times (starting with the beginning of life for the satellite all the way through the end of life of the satellite) such that the pressure of the gas 48 within the balloon exceeds the vapor pressure of the liquid fuel 34 inside of the tank 32 and within the heat exchanger 38. The balloon 46 is only partially filled with gas 48 before launch, so that as liquid fuel 34 is used (i.e., passes through valve 36, heater 40 and eventually nozzle 42), the gas 48 inside of the balloon 46 can expand the balloon 46 to take up space vacated by the liquid fuel that was used. This is illustrated in FIG. 2 (condition of the fuel tank 32 before any fuel 34 is used, where the volume of the balloon 46 is small) and FIG. 3 (condition of the fuel tank 32 after most of the fuel 34 is used, where the volume of the balloon 46 is large). The balloon 46 should have a sufficiently high strength so as not to burst at any time. Therefore, the balloon 46 should have a sufficient strength at a wide range of temperatures (from −50 C to +20 C) so as to remain sufficiently flexible. A balloon 46 with a sufficiently low gas permeation rate should be used, so that over the course of the satellite's mission, the gas in the partially filled balloon 46 does not permeate out into the main portion of the liquid fuel tank 32 and form a gas pocket within the liquid fuel tank 32.

On the ground before launch, the balloon 46 is partially filled with gas 48, and inserted into the fuel tank 32. Liquid fuel 34 is then added to the tank 32 (e.g., through valve 50), and the tank 32 is sealed. While on the ground before launch, the gas pressure within the tank is at approximately 1 atmospheric pressure (i.e., approximately the same pressure as the environment surrounding the launch site and/or the area in which the satellite is prepared for launch). In this way, the entire propulsion system 30 including the fuel tank 32 are not considered to be a pressure vessel since all of the components have a zero “gauge pressure” and are at the same pressure as the atmosphere in which launch will occur. This is significant advantage, since rocket launch range safety requirements for “pressure vessels” are much more stringent and add a lot of cost and complexity to testing, verification, and qualification. Once the satellite 10 with its propulsion system 30 are launched into space, the pressure outside of the fuel tank 32 drops to zero (the vacuum of space), while the pressure of the gas 48 inside the balloon 46 (and hence the liquid fuel 32 in the fuel tank 32) is substantially 1 atmosphere. As the liquid fuel 34 is used up, the balloon expands to keep providing pressure on the fuel 34 to drive fuel 34 through valve 36 when it is opened, through heater 40 and nozzle 42. The pressure inside of the balloon 46 decreases as the balloon 46 expands to take up space created by the fuel 34 leaving the tank 32, until all or mostly all of the liquid fuel 34 is used up. The initial volume of the balloon 46 is chosen such that the pressure remaining in the balloon 46 at the point the fuel tank 32 is completely or almost completely empty of fuel 34 (i.e., at the end of the life of the propulsion system) exceeds the vapor pressure of the liquid fuel 34 in the tank 32 and in the heat exchanger 38. For example, the initial volume of the balloon 46 can be chosen such that at the point that the fuel 34 in the tank 32 is depleted, the pressure in the expanded volume of the balloon 46 is 3.7 psi. In space, the balloon 46 also ensures that the liquid fuel 34 is always in pressure contact with the valve 36 for exiting the tank.

The propulsion system 30 is used to maneuver the satellite 10 after it has been launched into orbit. For example, the propulsion system 30 can maneuver the satellite 10 away from orbital space debris when a collision is predicted. Additionally, when multiple satellites 10 are launched into orbit with a single launch vehicle, the propulsion systems 30 can spread the multiple satellites 10 away from each other in a single orbital plane. Finally, the propulsion system 30 can maneuver the satellite 10 out of orbit (i.e., in response to a de-orbit command), so that satellite 10 de-orbits faster than would occur due to natural drag. The above described propulsion system 30 achieves increased performance and increased compactness.

The propulsion system 30 has many advantages. Storing the fuel as a liquid is important to be able to achieve a high impulse mass density (N-s/kg) and impulse volume density (N-s/L). In contrast, most cold gas propulsion system propellants are stored as pressurized gases with the use of a heavy pressurized propellant tank. The liquid fuel 34 can be, but is not limited to, ethanol, R236fa, Propane C3H8, Butane C4H10, Pentane C5H12, Hexane C6H14, n-Heptane C7H16, H2O, R134a, CO2, ethanoic acid, naphthalene, Benzoic acid, Diethyl Ether, Methyl Acetate, Fluorobenzene, Benzene, ethanol, methanol, isopropyl, acetone, Ethanol+H2O mixture, or Dibromomethane.

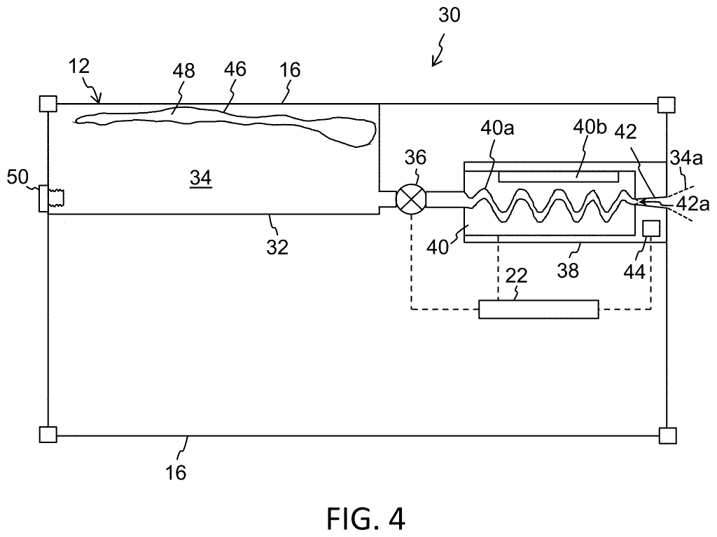

The fuel tank 32 can be disposed inside housing 12 as a standalone unit. However, preferably, the fuel tank is instead integrally formed as part of the housing 12 as shown in FIG. 4 (i.e., where one or more walls of the fuel tank 32 comprises a portion of frame 16 and/or side panel(s) 14). By avoiding having separate propellant tank and satellite frame components that are secured together, a single integrally formed tank and frame reduces mass and volume.

The balloon 46 is advantageous because it reduces the complexity of the propulsion system 30 (i.e., avoiding multiple fuel valves, other moving parts, etc. that add mass and weight and increase the number of elements that could fail over time in the extreme environment of space). The satellite 10 avoids being certified as a “pressure vessel” for launch on a rocket, which avoids a lot of time, expense and complexity with additional requirements for launching a pressure vessel, such as triple redundant seals. The configuration of propulsion system 30 avoids the need for a series of additional moving parts (valves and pumps) for injecting propellant into a heater for vaporizing the fuel. It also prevents the gas 48 from mixing with the fuel 34, and therefore prevents the gas 48 from escaping through the valve 36 with the fuel 34, thus leaving the tank 32 underpressurized in relation to the remaining fuel 34 in the tank 32 (i.e., keeping the gas 48 in the balloon 46 ensures that the gas 48 remains inside the tank 32 for properly pressurizing the fuel 34). The heat exchanger 38 with nozzle 42 is advantageous because it is a single assembly, which reduces the number of parts, mass and volume, and thus increases reliability. A low thermal conductivity material is preferably used between the heat exchanger 38 and the valve 36 to reduce the conducted heat transfer between the heat exchanger 38 and the colder tank 32 or other components in the satellite 10, and thus reduces total energy required for a firing of the propulsion system 30. Likewise, a gold coating on the heat exchanger 38 can be used to reduce radiated heat transfer between the heat exchanger 38 and the colder tank 32 or other components in the satellite 10, and thus reduces total energy required for a firing of the propulsion system 30. A propulsion system with a single value and no active pumps reduces parts count, mass and volume, and increases reliability. Integrating the tank 32 with the satellite frame 16 also reduces parts count, mass and volume, and increases reliability.

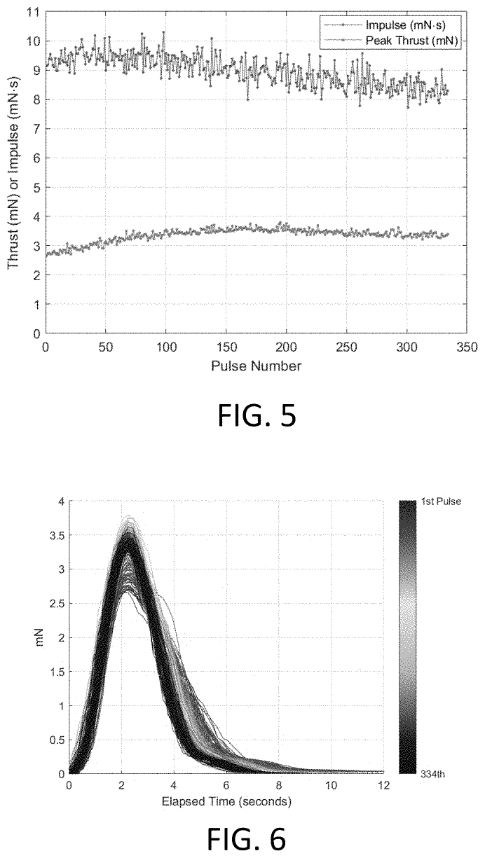

FIGS. 5 and 6 are graphs that show thrust performance that has been achieved by the above described propulsion system. Relatively stable pulse-to-pulse thrust is produced by a propulsion system that is non-pressurized at launch, and uses a cold gas (i.e., the fuel is not combusted to create thrust). The balloon 46 in tank 32 provides the pressurized fuel in the vacuum of space to create the thrust needed for the satellite 10.

It is to be understood that the present invention is not limited to the embodiment(s) described above and illustrated herein, but encompasses any and all variations falling within the scope of any claims. For example, references to the present invention herein are not intended to limit the scope of any claim or claim term, but instead merely make reference to one or more features that may be covered by one or more of the claims. Materials, processes and numerical examples described above are exemplary only, and should not be deemed to limit the claims. Hardware, software and/or firmware can be used to implement the functionality of the satellite 10. It should further be appreciated that functionality can be implemented as computer-executable instructions stored on a non-transitory computer readable medium, such a CD or DVD (including re-writable CDs and DVDs), flash or other non-volatile memory, ROM, EEPROM, disc drive, solid state drive, etc.

What is claimed is:

1. A propulsion system, comprising:
a tank;
an expandable balloon disposed in the tank;
a heater;
a valve providing liquid communication between the tank and the heater when in an open position and providing no liquid communication between the tank and the heater when in a closed position; and
a nozzle having an orifice in liquid communication with the heater.

2. The system of claim 1, wherein:
the tank contains liquid fuel; and
the expandable balloon contains a gas;
wherein the gas and the liquid fuel are at substantially 1 atmospheric pressure.

3. The system of claim 1, wherein the heater comprises:
a channel; and
a heating element configured to heat the channel.

4. The system of claim 3, wherein the channel is circuitous.

5. The system of claim 1, wherein the tank comprises a fill valve.

6. The system of claim 1, further comprising circuitry configured to control the valve and the heater.

7. The system of claim 6, further comprising:
a temperature sensor configured to detect a temperature of the heater, wherein the circuitry is configured to control the heater based upon the temperature detected by the temperature sensor.

8. A satellite, comprising:
a housing;
a circuit board containing circuitry and disposed in the housing;
a battery disposed in the housing and electrically connected to the circuit board;
a tank disposed in the housing;
an expandable balloon disposed in the tank;
a heater;
a valve providing liquid communication between the tank and the heater when in an open position and providing no liquid communication between the tank and the heater when in a closed position; and
a nozzle having an orifice in liquid communication with the heater.

9. The satellite of claim 8, wherein:
the tank contains liquid fuel; and
the expandable balloon contains a gas;
wherein the gas and the liquid fuel are at substantially 1 atmospheric pressure.

10. The satellite of claim 8, wherein the heater comprises:
a channel; and
a heating element configured to heat the channel.

11. The satellite of claim 10, wherein the channel is circuitous.

12. The satellite of claim 8, wherein the tank comprises a fill valve.

13. The satellite of claim 8, wherein the circuitry is configured to control the valve and the heater.

14. The satellite of claim 13, further comprising:
a temperature sensor configured to detect a temperature of the heater, wherein the circuitry is configured to control the heater based upon the temperature detected by the temperature sensor.

15. The satellite of claim 8, wherein at least a portion of the tank is integrally formed as part of the housing.

16. A method, comprising:
providing a satellite that comprises:
a housing,
a circuit board containing circuitry and disposed in the housing,
a battery disposed in the housing and electrically connected to the circuit board,
a tank disposed in the housing,
an expandable balloon disposed in the tank,
a heater,
a valve providing liquid communication between the tank and the heater when in an open position and providing no liquid communication between the tank and the heater when in a closed position, and
a nozzle having an orifice in liquid communication with the heater;
partially filling the expandable balloon with a gas;
loading liquid fuel into the tank;
launching the satellite into space after the providing, the partially filling and the loading;
after the launching:
opening the valve to cause the liquid fuel from the tank to pass into the heater under pressure provided by the gas in the expandable balloon;
activating the heater to heat and vaporize the liquid fuel in the heater into a fuel vapor; and
expelling the fuel vaper out of the nozzle.

17. The method of claim 16, wherein after the partially filling and the loading, and before the launching, the gas and the liquid fuel are at substantially 1 atmospheric pressure.

18. The method of claim 16, wherein the heater comprises:
a channel through which the liquid fuel flows when the valve is opened; and
a heating element configured to heat the channel.

19. The method of claim 18, wherein the channel is circuitous.

20. The method of claim 16, wherein the circuitry is configured to control the opening of the valve and the activating of the heater.
